(19) United States
(12) Patent Application Publication
(10) Pub. No.: US 2010/0096236 A1
(43) Pub. Date: Apr. 22, 2010

(54) ONE-WAY CLUTCH OF ROLLER TYPE

(75) Inventor: TOMOHARU ANDO, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/581,862

(22) Filed: Oct. 19, 2009

(30) Foreign Application Priority Data
Oct. 20, 2008 (JP) 2008-269766

(51) Int. Cl. F16D 15/00

(52) U.S. Cl. 192/45

(57) ABSTRACT

The present invention provides a one-way clutch comprising an outer race provided with a pocket, an inner race arranged coaxially with the outer race, a roller adapted to transmit torque between the outer race and the inner race, a cage having a cylindrical portion with a window and a flange portion extending from the cylindrical portion in an outer diameter direction, the window being adapted to hold the roller and enclosed at its four sides, a spring disposed in the pocket between the outer race and the roller and adapted to bias the roller toward an engagement direction with respect to the cam surface, and a side plate secured to abut against an axial one end face of the outer race and provided at its inner diameter portion with spline grooves, and wherein the side plate has at least one grooved portion having one end communicated with the pocket of the outer race and the other end opened to an outer diameter end of the side plate.

This application claims the benefit of Japanese Patent Application No. 2008-269766, filed Oct. 20, 2008, which is hereby incorporated by reference herein in its entirety.

### BACKGROUND OF THE INVENTION

1. Field of the Invention

The present invention relates to a one-way clutch of roller type used as a part such as a torque transmitting element or a back stopper in a driving apparatus of a motor vehicle, an industrial machine and the like, for example.

2. Related Background Art

In general, a one-way clutch of roller type is comprised of an outer race having at least one pocket provided at its inner periphery with a cam surface, an inner race disposed in concentric with the outer race and having an outer peripheral track surface, a roller disposed within the pocket and adapted to transmit torque between the outer peripheral track surface of the inner race and the inner peripheral cam surface of the outer race, and a spring contacted with an idle rotation side of the roller.

With this arrangement, in the one-way clutch, the inner race is designed so as to be rotated only in one direction with respect to the outer race by means of a cam mechanism constituted by the roller and the cam surface. That is to say, the inner race is designed so that it is idly rotated relative to the outer race in one direction, and on the other hand, it applies rotational torque to the outer race via the cam mechanism only in an opposite direction.

For example, since a one-way clutch used as a starter of a motor bike is used under a high speed rotation and great vibration condition and a severe condition in which the clutch is exposed to powder dust, foreign matters such as dust including worn powder are apt to be accumulated in the one-way clutch. Since the foreign matters accumulated in the one-way clutch affect a bad influence upon engaging performance, it is preferable to remove the foreign matters promptly in order to enhance the performance of the one-way clutch.

On the other hand, in some one-way clutches of roller type used as the starter of the motor bike, as disclosed in Japanese Patent Application Laid-open No. 5-044615 (1993), a side plate provided at its inner diameter portion with spline grooves with which a member such as a crankshaft of an engine is engaged is bolted to an outer race of the one-way clutch.

Further, in order to enhance the performance of the one-way clutch, it has been proposed to lubricate the members. For example, the above-mentioned Japanese Patent Application Laid-open No. 5-044615 (1993) discloses an arrangement in which a one-way clutch is lubricated by oil. Further, some one-way clutches have been used under a dry condition without oil lubrication.

In this way, in the one-way clutch used as the starter of the motor bike having the side plate provided at its inner diameter portion with spline grooves, it is desired to provide a one-way clutch of roller type in which the engaging reliability can be maintained even under the high speed rotation and great vibration condition and the severe condition in which the foreign matters such as the dust including the worn powder are apt to be accumulated.

Although it is considered to form grooves for removing the foreign matters in an axial end face of the outer race, if such grooves are formed during forging of the outer race, when cutting for finishing the end face of the outer race is performed, intermittent cutting is required, thereby arising problems regarding formation of burr and/or reduction in a service life of a tool. On the other hand, if the grooves are formed after the cutting of the end face, the number of manufacturing steps is increased, thereby increasing a manufacturing cost.

### SUMMARY OF THE INVENTION

Accordingly, an object of the present invention is to provide a one-way clutch of roller type wherein reliability is enhanced by providing an arrangement in which foreign matters such as dust including worn powder accumulated in the one-way clutch can be discharged and to realize reduction in cost by providing the arrangement in which the foreign matters can be discharged without special working.

To achieve the above object, the present invention provides a one-way clutch of roller type comprising an annular outer race provided at its inner periphery with at least one pocket formed as a recessed portion having a cam surface and having a stepped portion formed at an inner diameter side of one axial end face of the outer race; an inner race spaced apart from the outer race toward a radial inner diameter side of the outer race and coaxially arranged for a relative rotational movement and having an annular outer peripheral track surface; a roller disposed in the pocket and adapted to transmit torque between the outer peripheral track surface of the inner race and the inner peripheral cam surface of the outer race, a cage rotatable relative to the outer race and having a cylindrical portion with a window and a flange portion extending from the cylindrical portion in an outer diameter direction and fitted into the stepped portion of the outer race, the window having a circumferential window width smaller than a diameter of the roller and passing through the cage in a radial direction but closed at both ends in the axial direction i.e. the window being enclosed at its four sides to define a substantially rectangular window into which the roller is seated; a spring disposed in the pocket between the outer race and the roller and adapted to bias the roller toward an engagement direction with respect to the cam surface; and a side plate secured to abut against the axial one end face of the outer race including the stepped portion and provided at its inner diameter portion with spline grooves; and wherein the side plate has at least one grooved portion having one end communicated with the pocket of the outer race and the other end opened to an outer diameter end of the side plate.

Further, preferably, in the one-way clutch of roller type according to the present invention, the one end of the grooved portion is communicated with a maximum diameter portion of the pocket.

Further, preferably, in the one-way clutch of roller type according to the present invention, the grooved portion extends along a straight line.

Further, preferably, in the one-way clutch of roller type according to the present invention, the grooved portion extends along a curved line.

Further, preferably, in the one-way clutch of roller type according to the present invention, a portion of the grooved portion is constituted by a flat surface.

Further, preferably, in the one-way clutch of roller type according to the present invention, a portion of the grooved portion is constituted by a curved surface.

Further, preferably, in the one-way clutch of roller type according to the present invention, the grooved portion is formed by press working.

In the one-way clutch of roller type according to the present invention, by forming the at least one grooved portion having the one end communicated with the pocket of the outer race and the other end opened to the outer diameter end of the side plate in the axial one end face of the side plate abutting against the axial one end face of the outer race including the stepped portion, foreign matters such as dust are discharged along the grooved portion by a centrifugal force generated by a rotation of the outer race, with the result that obstruction of the operation of the cage caused by the accumulation of the foreign matters can be prevented and wear of surfaces of the roller, spring, inner race and outer race can also be prevented, thereby providing a one-way clutch of roller type having more enhanced reliability.

Further, since the grooved portion can be formed in the side plate only by the press working, any special manufacturing costs are not required, thereby achieving reduction in cost.

In addition, by the side plate provided at its inner diameter portion with the spline grooves for transmitting a power between the outer race and a crankshaft of an engine, and by the cage including the window having the circumferential window width smaller than the diameter of the roller in the circumferential direction and passing through the cage in the radial direction but closed at both ends in the axial direction i.e. the window being enclosed at its four sides to define the substantially rectangular window into which the roller is seated and also including the flange portion provided at the axial one end of the pocket, the roller can be prevented from being dislodged from the cage both in axial direction and in the inner diameter direction.

Further, by fitting the flange portion of the cage into the stepped portion provided on the inner diameter portion of the end face of the outer race and by securing the side plate to the end face of the outer race near the flange portion, the dislodgement of the cage is prevented.

Furthermore, by designing so that the cage can be rotated relative to the outer race, when the circumferential window width of the cage is smaller than the diameter of the roller to prevent the dislodgement of the roller in the radial direction, since the cage does not obstruct the movement of the roller during the engaging operation of the one-way clutch and during the idle rotation, smooth engagement and idle rotation can be realized, and, regarding the movements of all rollers, the cage affords the synchronous action, thereby providing a one-way clutch of roller type having more excellent engaging reliability.

Further features of the present invention will become apparent from the following description of an exemplary embodiment with reference to the attached drawings.

### BRIEF DESCRIPTION OF THE DRAWINGS

FIG. 1 is a front view showing a one-way clutch of roller type according to an embodiment of the present invention in a condition that the clutch is engaged under a high load.

FIG. 2 is a sectional view taken along the line 2-O-2 of FIG. 3.

FIG. 3 is a front view looked at from a rear side of FIG. 1.

FIG. 4 is an enlarged front view of a grooved portion of the one-way clutch of roller type according to the embodiment of the present invention, showing a sectional view taken along the line 4-4 of FIG. 5.

FIG. 5 is a front view looked at from a rear side of FIG. 1.

FIG. 6 is an enlarged front view of the grooved portion of the one-way clutch of roller type according to the embodiment of the present invention, showing a sectional view taken along the line 6-6 of FIG. 5.

### DETAILED DESCRIPTION OF THE INVENTION

Now, an embodiment of the present invention will be fully explained with reference to the accompanying drawings. Incidentally, in the drawings, same or similar parts or elements are designated by the same reference numerals. Further, it should be noted that the embodiment which will be described below is merely an example and other alterations and modifications can be made.

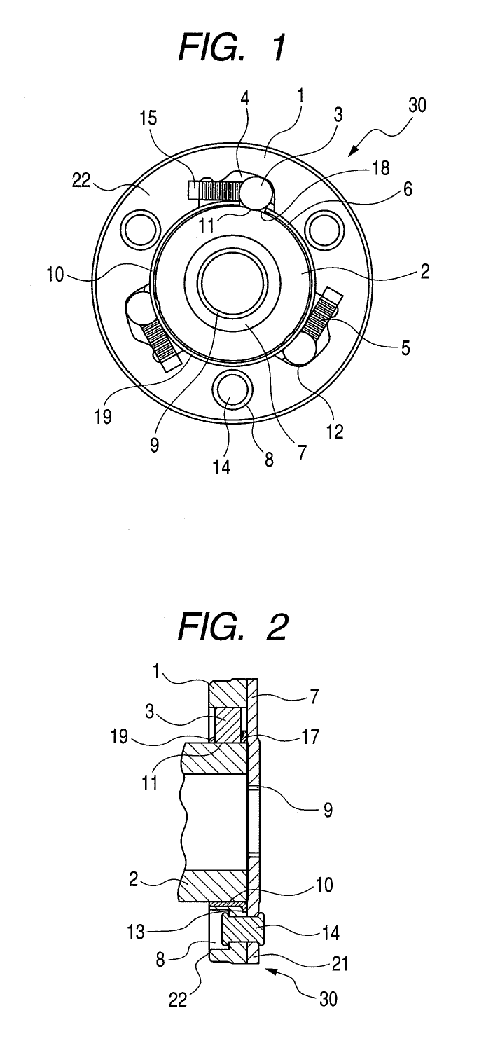

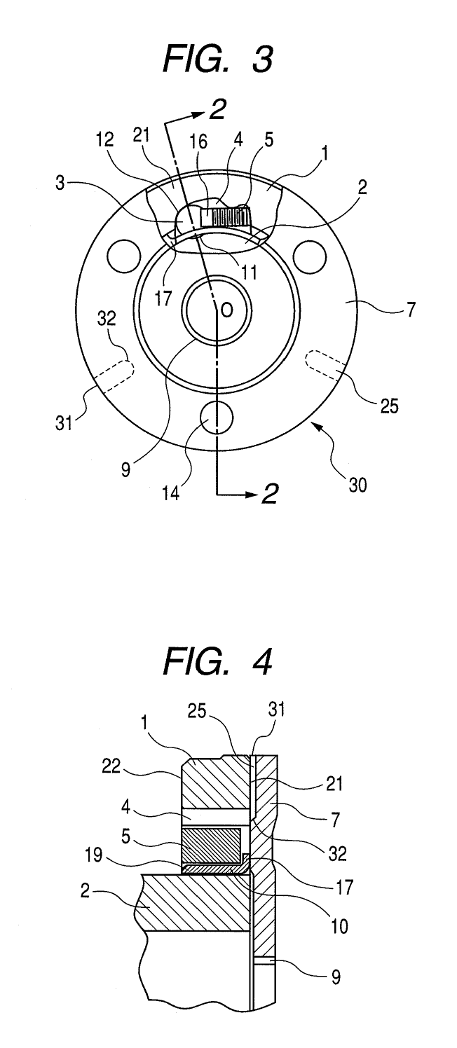

FIG. 1 is a front view showing a one-way clutch of roller type according to an embodiment of the present invention, and FIG. 3 is a front view looked at from a rear side of FIG. 1. Further, FIG. 2 is a sectional view taken along the line 2-O-2 of FIG. 3.

FIGS. 1 to 3 show a condition that rollers are engaged by cam surfaces, i.e. a condition that the one-way clutch is engaged under a high load and is locked.

As shown in FIGS. 1 to 3, a one-way clutch 30 of roller type comprises an annular outer race 1 provided at its inner periphery with a plurality of pockets 4 formed as recessed portions having cam surfaces 12, an inner race 2 spaced inwardly from the outer race 1 in a radial direction and rotatable relative to the outer race and disposed in concentric with the outer race and having an annular outer peripheral track surface 11, rollers 3 disposed in the respective pockets 4 and adapted to transmit torque between the outer peripheral track surface 11 of the inner race 2 and the inner peripheral cam surfaces 12 of the outer race 1, springs 5 disposed in the respective pockets 4 and adapted to bias the rollers 3 toward engagement directions with respect to the cam surfaces 12, a cage 6 for holding the rollers 3, and a side plate 7 provided at its inner diameter portion with spline grooves 9 with which a crankshaft of an engine can be engaged and secured to the outer race 1 by rivets 14 so that the side plate abuts against an axial end face 21 of the outer race 1. The cage 6 is not secured to either the outer race 1 or the inner race 2, and, thus, can be rotated relative to the outer race 1 and the inner race 2.

In the illustrated embodiment, there are three pockets 4 provided in the outer race 1, which pockets are disposed equidistantly along a circumferential direction. Further, three rivet holes 8 used for securing the side plate 7 to the outer race 1 by means of the rivets 14 and extending through the outer race in an axial direction are also disposed equidistantly along the circumferential direction, and the pockets 4 and the rivet holes 8 are arranged alternately and equidistantly along the circumferential direction. Of course, it should be noted that the number of the pockets 4 can be set to be three to six, for example, in accordance with the magnitude of the torque.

As shown in FIGS. 2 and 3, the cage 6 for holding the rollers 3 comprises a cylindrical portion 10 and an annular flange portion 17 extending radially outwardly from an axial one end of the cylindrical portion 10. Incidentally, in FIG. 3, the flange portion 17 and the side plate 7 are partially broken so that the pockets 4 can be seen.

Further, the cage 6 has windows 18 the number of which corresponds to the number of rollers 3. The window 18 extends through the cage in the radial direction, but, in the axial direction, both an end of the window near the flange portion 17 and an end 19 remote from the flange portion 17 are closed. In the circumferential direction, a width of the window is smaller than a diameter of the roller. That is to say, the roller 3 is seated in a substantially rectangular window 18 encircled at its four sides, thereby preventing the roller 3 from being dislodged in the inner diameter direction. To show a relationship between the window 18 and the roller 3, in FIG. 1, the end 19 of the uppermost window 18 is broken away.

One end i.e. tab 15 of each spring 5 is locked to the axial end face of the outer race 1, as shown in FIG. 1, and, the other end i.e. tab 16 of the spring is pinched between an axial end face of the roller 3 and the flange portion 17 of the cage 6, as shown in FIG. 3. With this arrangement, the spring 5 itself is fixedly supported with respect to the outer race 1, with the result that dislodgement of the spring 5 can be prevented and, at the same time, the roller 3 can be prevented from being dislodged in the axial direction.

In the illustrated embodiment, although an accordion spring is used as the spring 5, other type of spring such as a coil spring can be used.

As shown in FIGS. 2 and 3, an annular stepped portion 13 is provided on an axial edge portion of the inner peripheral surface of the outer race 1, and the flange portion 17 of the cage 6 is engaged by the stepped portion 13. By securing the side plate 7 to the outer race 1 so that the flange portion 17 of the cage 6 is engaged by the stepped portion 13 and the side plate abuts against the axial end face 21 of the outer race 1, the dislodgement of the cage 6 can be prevented.

An axial depth of the stepped portion 13 is slightly greater than a thickness of the flange portion 17 so that, when the flange portion 17 is engaged by the stepped portion 13, a clearance is generated between an axial end face of the outer race 1 and an axial end face of the flange portion 17. Thus, the cage 6 can be rotated relative to the outer race 1 and the dislodgement of the cage 6 in the axial direction can be prevented.

As shown in FIG. 3, the side plate 7 is provided with a plurality of grooved portions 25 the number of which corresponds to the number of pockets 4. Each grooved portion 25 has a predetermined circumferential width and extends from an outer diameter end 31 of the side plate 7 toward an inner diameter side along a substantially straight line. One end of the grooved portion 25 near the inner diameter side i.e. terminal end 32 is located between the inner and outer diameter portions and at a position where the grooved portion is communicated with the pocket 4 as will be described later. As shown in FIGS. 4 and 6, the grooved portion 25 has a predetermined axial depth.

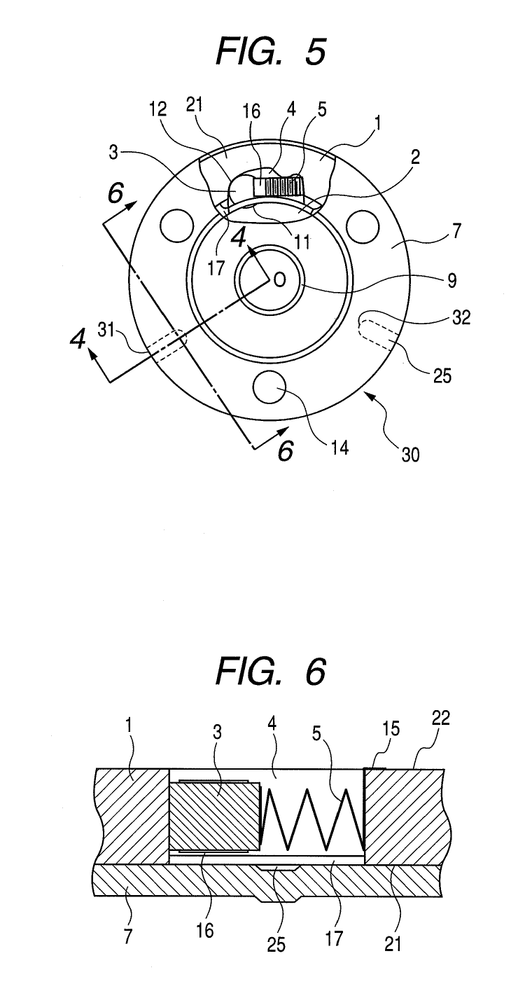

FIG. 4 is an enlarged front view of the grooved portion of the one-way clutch of roller type according to the embodiment of the present invention, showing a sectional view taken along the line 4-4 of FIG. 5. FIG. 5 is a front view looked at from a rear side of FIG. 1, and FIG. 6 is an enlarged front view of the grooved portion of the one-way clutch of roller type according to the embodiment of the present invention, showing a sectional view taken along the line 6-6 of FIG. 5.

As shown FIGS. 4 and 6, the grooved portion 25 is provided in an axial one end face of the side plate 7 which abuts against the axial one end face 21 of the outer race 1 so that the terminal end 32 is communicated with the pocket 4 and extends therefrom toward the outer diameter direction of the pocket 4 and the other end is opened to outside at an outer diameter end face 31 of the side plate 7.

By providing the grooved portion 25 having such an arrangement, when the outer race 1 is rotated, foreign matters such as worn power and/or dust accumulated in the pocket 4 of the outer race 1 enter into the grooved portion 25 communicated with the pocket 4 at the terminal end 32 by a generated centrifugal force and then shift the outer diameter direction along the grooved portion 25 and then are discharged out of the one-way clutch 30 through an outer diameter end 31 of the side plate 7.

In the illustrated embodiment, although one grooved portion 25 is provided in correspondence to each pocket 4, it should be noted that a plurality of grooved portions may be provided, if necessary.

Further, it is preferable that the terminal end 32 of the grooved portion 25 is communicated with a maximum diameter portion of the cam surface 12 of the pocket 4. The term “maximum diameter portion” means a portion which is located nearest to the outer diameter of the cam surface and which includes an area having a maximum radial distance from the outer peripheral track surface 11 of the inner race 2. Since the grooved portion 25 is communicated with the maximum diameter portion, the foreign matters such as worn powder and/or dust accumulated in the outer diameter portion of the pocket 4 of the outer race 1 enter into the grooved portion 25 more positively and then shift along the grooved portion 25 and then are discharged out of the one-way clutch 30.

Further, in the illustrated embodiment, while an example that the grooved portion 25 extends along the straight line was explained, the grooved portion may extend along a curved line. Further, in the illustrated embodiment, while an example that the grooved portion 25 extends radially in the radial direction of the outer race 1 was explained, the grooved portion may be inclined by a predetermined angle with respect to the radial direction.

Although a part of the grooved portion 25 is constituted by a flat surface, the grooved portion may be constituted by a curved surface. Further, a bottom surface of the grooved portion may be tapered so that the bottom surface of the grooved portion 25 is more deepened toward the outer diameter end 31 of the outer race 1. By doing so, the foreign matters accumulated in the pocket 4 can be discharged out of the clutch more efficiently through the grooved portion 25.

Further, although the grooved portion 25 is formed by press working, it may be formed by cutting. Furthermore, the grooved portions may be formed simultaneously with forging of the side plate 7.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

What is claimed is:

1. A one-way clutch of roller type comprising:
an outer race provided at its inner periphery with at least one pocket having a cam surface and having a stepped portion formed at an inner diameter side of one axial end face of said outer race;
an inner race spaced apart from said outer race toward a radial inner diameter side of said outer race and coaxially arranged for a relative rotational movement;
a roller disposed in said pocket and adapted to transmit torque between said outer race and said inner race when engaged by said cam surface;
a cage rotatable relative to said outer race and having a cylindrical portion with a window and a flange portion extending from said cylindrical portion in an outer diameter direction and fitted into said stepped portion of said outer race, said window having a circumferential width smaller than a diameter of said roller and adapted to hold said roller;
a spring disposed in said pocket between said outer race and said roller and adapted to bias said roller toward an engagement direction with respect to said cam surface; and
a side plate secured to abut against an axial one end face of said outer race and provided at its inner diameter portion with spline grooves; and wherein
said side plate has at least one grooved portion having one end communicated with said pocket of said outer race and the other end opened to an outer diameter end of said side plate.

2. A one-way clutch of roller type according to claim 1, wherein said one end of said grooved portion is communicated with a maximum diameter portion of said pocket.

3. A one-way clutch of roller type according to claim 1, wherein said grooved portion extends along a straight line.

4. A one-way clutch of roller type according to claim 1, wherein said grooved portion extends along a curved line.

5. A one-way clutch of roller type according to claim 1, wherein a portion of said grooved portion is constituted by a flat surface.

6. A one-way clutch of roller type according to claim 1, wherein a portion of said grooved portion is constituted by a curved surface.

7. A one-way clutch of roller type according to claim 1, wherein said grooved portion is formed by press working.

8. A one-way clutch of roller type comprising:
an outer race provided at its inner periphery with at least one pocket having a cam surface and having a stepped portion formed at an inner diameter side of one axial end face of said outer race;
an inner race spaced apart from said outer race toward a radial inner diameter side of said outer race and coaxially arranged for a relative rotational movement;
a roller disposed in said pocket and adapted to transmit torque between said outer race and said inner race when engaged by said cam surface;
a cage rotatable relative to said outer race and having a cylindrical portion and a window provided in said cylindrical portion and adapted to hold said roller;
a spring disposed in said pocket between said outer race and said roller and adapted to bias said roller toward an engagement direction with respect to said cam surface; and
a side plate secured to abut against an axial one end face of said outer race;
and wherein
said side plate has at least one grooved portion having one end communicated with said pocket of said outer race and the other end opened to an outer diameter end of said side plate.
